(19) United States
(12) Patent Application Publication
(10) Pub. No.: US 2005/0271808 A1
(43) Pub. Date: Dec. 8, 2005

(54) Process and apparatus for layer by layer assembly of reinforced composite materials

(75) Inventors: Dennis Reust, Stillwater, OK (US); Arif Mamedov, Stillwater, OK (US); Philip Vickery, Stillwater, OK (US); Lloyd Salsman, Stillwater, OK (US)

Correspondence Address: DUNLAP, CODDING & ROGERS P.C., PO BOX 16370, OKLAHOMA CITY, OK, 73113, US

(73) Assignee: Nomadics, Inc.

(21) Appl. No.: 11/088,493

(22) Filed: Mar. 24, 2005

Related U.S. Application Data
(60) Provisional application No. 60/556,233, filed on Mar. 25, 2004.

(51) Int. Cl. B05C 3/00; B05D 7/22; B05D 1/18

(52) U.S. Cl. 427/230; 427/402; 427/430.1; 118/400; 118/408

(57) ABSTRACT

An apparatus for forming a composite material having a plurality of layers disposed on at least a portion of at least one substrate includes at least one deposition cell, at least two reservoirs and a deposition system. The at least one deposition cell has at least one substrate. Each of the at least two reservoirs are adapted to contain a deposition material for forming the plurality of layers of the composite material. The deposition system is in fluid communication with the reservoirs for selectively removing the deposition materials from the reservoirs and traversing the deposition materials near the at least one substrate such that separate layers of the deposition materials are disposed on at least a portion of the at least one substrate to form the composite material.

### CROSS-REFERENCE TO RELATED APPLICATIONS

This application claims the benefit under 35 U.S.C. 119(e) of U.S. Provisional Application Ser. No. 60/556,233, filed Mar. 25, 2004, the contents of which are hereby expressly incorporated by reference herein in its entirety.

### BACKGROUND OF THE INVENTION

Technology for making precision articles is an advancing industry. There are two general approaches for making articles: the “top down” approach and the “bottom up” approach. The top down approach to making articles is where one uses a large mass of material and purifies it, alloys it, and removes unwanted portions, for example by using machining or etching techniques, to make the structure. Of more recent development is the bottom up approach, where the structure is built from the bottom up by assembling atoms or molecules in desired relationships and spatial configurations. By assembling molecules in a preferred order, materials of superior characteristics can be formed.

In general, prior art for layer by layer assembly of materials involves a process wherein monomolecular layers are sequentially added to a supported substrate by traversing the substrate along a series of stations wherein the substrate is dipped into a bath of one chemical solution or suspension after another. Usually the substrate will also be traversed to and dipped into water or other rinsing solution in between each of the chemical solutions or suspension baths. For example, a substrate, such as a glass slide support coated with a cellulose acetate, is traversed to and dipped into a bath having an aqueous suspension of cations, where it stays for several minutes to allow time for a unimolecular layer to form on the substrate. Then the substrate is traversed to a rinsing station where it is rinsed by dipping it into a constantly refreshed water bath, where it soaks to remove excess material before being traversed to and dipped into another bath having an aqueous suspension of anions, where it soaks for several minutes to form a unimolecular layer. Another rinse cycle takes place, completing the deposition of a one layer of cations and one of anions. This is referred to as one layer, or one double layer. The process repeats until the desired number of layers is deposited. Because the ions diffuse slowly in a solvent, the soak times in each bath may extend from a few minutes to an hour. Stirring is sometimes used to mitigate the time penalty of slow diffusion rates.

In the simplest implementation, human labor is used to move the substrates from bath to bath. This limits operation of the system to available work hours. Further, human labor can have implications on process repeatability. A logical improvement employs robotic machines to move the substrates from bath to bath at specified time intervals. With moderate capital investments for such machines, labor savings are realized and the feasibility of operating “around the clock” is improved. With lengthy deposition times, around the clock operation is an important improvement. However, even with automation, it can take up to a week to make a 100 layer film. Further, another problem with such prior art systems is that the bath stations and/or other machinery, such as conveyor systems and robotic arms, can be complex and require a large amount of an operator's real estate.

Other limitations on scaling up production with prior art methods are that the size and shape of substrates, as well as the number of substrates, which can be immersed into a bath at once is limited by the relative sizes of the substrates and bath receptacles. Further limitations on substrate size, shape, and number arise in the case of automation with regard to the handling capabilities of the robot machinery and the capacity of the work space available. Also, to form a large number “n” of layers, substrates must either move through “n” number of baths plus rinse baths in an assembly line mode, or else be repeatedly submersed in a number of baths at least equal to the number of material types to be deposited, plus the rinse baths therebetween, in a batch mode of operation.

The dipping process, whether manual or robotic, is realistically a batch process. A batch of one or more substrates is dipped into a small set of chemical baths multiple times in succession, until the entire process is finished. The substrate is dipped into the same bath at least once for each double layer to be formed. Process output of perhaps one batch per week might be expected. It is hardly feasible to “pipeline” or “streamline” the dipping process because each bath is used multiple times. To pipeline would require a separate bath for each dipping operation. There would be one bath of each chemical solution or suspension, multiplied by the number of layers. For 100 double layers, this totals 200 chemical baths plus two or more rinse baths. This would require a large amount of real estate and chemical handling, and a physically large dipping machine.

To scale up the dipping process, the more feasible option is to provide larger baths and a larger dipping machine, so that more or larger substrates can be dipped at a time into the baths. This produces larger batches and/or films. Scaling up further requires either duplication of the entire system, or still larger dipping machines, and baths. One can predict large capital expenditures when products or production requirements change. A company named NanoSonic, Inc. of Christiansburg, Va., advertises a dipping machine which can handle substrates up to 12×12 inches square, and up to 10 pounds in weight. One can imagine building much larger machines with much larger baths for a production line. However, there are some cost-to-benefit issues which need to be addressed by an operator.

Common substrates in prior art systems are glass microscope slides, and common bath containers are glass beakers. If the objective is to produce a long item, such as a 50 foot long tape, which might be used to wrap a mandrel and make a composite structure, another problem comes to light. It is difficult to arrange such long baths and handle the substrates, as the dipping process is generally best suited to thin rectangular objects which are restricted in their aspect ratio of X to Y dimensions.

Prior art for layer by layer assembly of materials, wherein the substrate is traversed through and dipped into a series of baths, can be time and space consuming, expensive, and inefficient. Therefore, there is a need for a more efficient method and apparatus for layer by layer assembly of material. It is to such a method and apparatus that the present invention is directed.

### SUMMARY OF THE INVENTION

The present invention relates to a process and apparatus for layer by layer assembly of a composite material. Such composite material may form ultra-thin free standing membranes, films, fabrics, or other flexible or rigid structures which can be used in various applications. For example, the composite material can form coatings or linings on the interior and/or exterior of other articles, such as for example tubing, containers, tanks, boards, or other substrates. Exemplary coating properties may improve electrical conductivity, increase radiative transmission or reception, protect by increasing corrosion resistance, reduce friction, restore eroded material, promote cell growth, and/or provide color films, optical coatings, or optical filters. Further, the composite material can be formed into or integrated into durable fabrics for use in making tents, water resistant clothing, or bullet proof vests, for example. The composite material can also be formed into high strength corrosion resistant structural members for high stress applications, such as rocket nose cones and aerospace vehicle wing coverings, for example.

The process and apparatus of the present invention improves layer by layer coating scalability by traversing several deposition materials in sequence to one or more stationary substrates. In contrast with prior art in which the substrate is traversed to and immersed sequentially in multiple fixed-point baths, the inventive process of the present invention allows stationary substrates to be coated in place, layer by layer.

In one embodiment of the present invention, a plurality of layers cooperate to form a composite material which is disposed on at least a portion of a substrate. The layers of the composite material are formed as deposition materials are traversed in sequence into a deposition cell which either forms or encloses at least a portion of the substrate. In one embodiment, the deposition materials are pumped through channels to and from the deposition cell, and each of the deposition materials are in a fluid or semi-fluid solution to facilitate pumping of the deposition materials to and from the deposition cell. Preferably, each solution is a suspension so as to reduce settling of the deposition material in the solution.

In one embodiment of the present invention, the deposition cell includes a substrate having an interior space defined by an interior surface, at least a portion of which is to be coated with the composite material. The substrate can be for example a glass or plastic tubing, container, or tank. The interior space of the substrate is filled with a deposition material, then drained, rinsed, and filled with the same or another disposition material in sequence, so as to form the plurality of layers of the composite material such that the composite material is disposed on at least a portion of the interior surface of the substrate.

Further, the substrate, or portions thereof, can be removable so that the substrate functions similar to a mold. In such an embodiment, the substrate is used to give a predetermined shape to the composite material. The inventive layer by layer deposition of the present invention is repeated enough times to make a structure made of the composite material directly. This embodiment of the present invention can be utilized to directly form carbon nanotube composite structures, such as a rocket nose cone for example, without the prior art labor intensive step of winding a tape around a mandrel, and thereby eliminating voids or pin holes.

In another embodiment of the present invention, the deposition cell includes a substrate having an exterior surface and a container having an interior space. At least a portion of the substrate is disposed in the interior space of the container. At least a portion of the interior space of the container is filled with the deposition material, then drained, rinsed, and filled with the same or another deposition material in sequence so as to form the plurality of layers of the composite material such that the composite material is disposed on at least a portion of the exterior surface of the substrate.

In one embodiment, when the deposition cell includes a container, the container can further include one or more confinement surfaces which partially or totally confine the deposition materials from at least a portion of the substrate so that at least a portion of the substrate is not exposed to the deposition materials. In another embodiment, to prevent at least a portion of the substrate from being exposed to the deposition materials, the substrate can have removable portions, which serve as temporary surfaces, so that after the composite material is formed on at least a portion of the substrate (including at least a portion of the removable portions), the removable portions can be removed thereby leaving adjacent portions of the substrate free of the composite material. The objective of such embodiments is to apply a coating to at least a portion of the substrate using the inventive process without immersing or exposing the entire substrate to a deposition material bath.

### BRIEF DESCRIPTION OF THE DRAWINGS

FIG. 1a is a block diagram of one embodiment of an apparatus constructed in accordance with the present invention.

FIG. 1b is a block diagram of one embodiment of a deposition cell.

FIG. 1c is a block diagram of another embodiment of the deposition cell.

FIG. 2 is a block diagram of a composite material formed on a substrate in accordance with the present invention.

FIG. 3a is a top elevational view of a container constructed in accordance with the present invention.

FIG. 3b is a bottom elevational view of a container constructed in accordance with the present invention.

FIG. 4a is an elevational view of one embodiment of the apparatus.

FIG. 4b is an elevational view of another embodiment of the apparatus depicted in FIG. 4a.

FIG. 4c is an elevational view of a deposition cell of the apparatus depicted in FIG. 4b.

FIG. 5 is an elevational view of another embodiment of the apparatus.

FIG. 6a is an elevational view of another embodiment of the apparatus.

FIG. 6b is an elevational view of a deposition cell of the apparatus depicted in FIG. 6a.

### DETAILED DESCRIPTION OF THE INVENTION

Generally stated, the present invention relates to a process and apparatus for making a composite material in a layer by layer fashion by automatically traversing one or more deposition materials, preferably in fluid solutions, to at least one near fixed-point substrate on which the composite material is formed. In one embodiment, solutions having the deposition materials therein are traversed from reservoirs to and from at least one deposition cell which includes at least one substrate to be coated. In one embodiment, to accomplish the process the apparatus includes at least one pump, at least one selector valve, at least one deposition cell(s), at least two material reservoirs which store at least two fluid solutions containing molecules with an affinity for one another, a plurality of channels having tubing or piping used as fluidic pathways, and a controller which may or may not be a personal computer. In one embodiment, the apparatus further includes the ability to rinse or otherwise purge materials from parts of the apparatus (e.g., the pump, valves, and tubing).

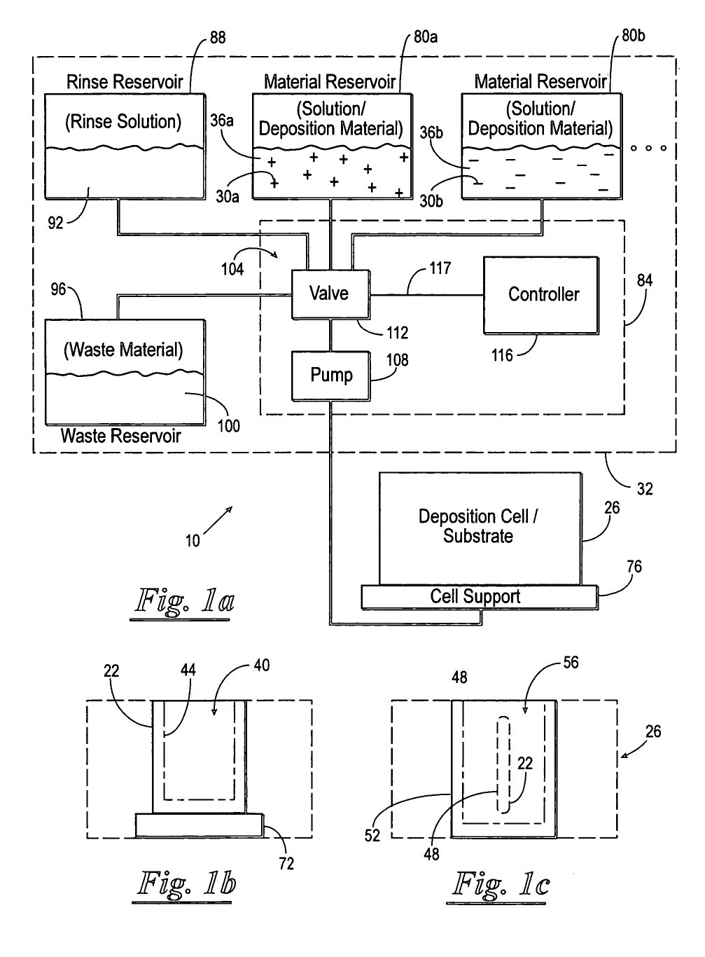

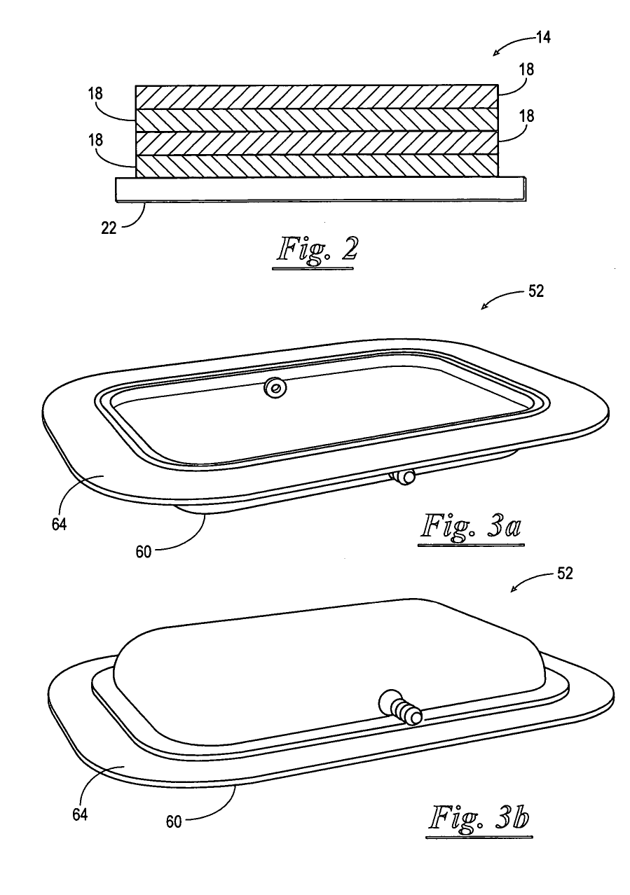

Referring now to the drawings, in particular to FIG. 1a, shown therein is a block diagram of an apparatus 10 for forming a composite material 14 (see FIG. 2) comprising a plurality of layers 18 on at least a portion of a substrate 22. The apparatus 10 includes a deposition cell 26 having the substrate 22, at least one or more deposition material 30 (only two being shown for purposes of clarity) and labeled by the reference numerals 30a and 30b for forming the plurality of layers 18 of the composite material 14, and a deposition system 32 for traversing the at least one deposition material 30 near the substrate 22 such that one layer 18 of the at least one deposition material 30 is disposed on at least a portion of the substrate 22 or on a previously disposed layer 18.

Although the deposition cell 26 is generally discussed herein with regard to including one substrate 22 for purposes of clarity, it should be understood that the apparatus 10 can include more than one substrate 22. Further, although the apparatus 10 is generally discussed herein as including one deposition cell 26 for purposes of clarity, it should be understood that the apparatus 10 can have more than one deposition cell 26, wherein each deposition cell 26 includes one or more substrates 22.

The substrate 22 is preferably in a near fixed-point position in the apparatus 10 while the composite material 14 is being formed. However, the substrate 22 can also be moved, such as for example by vibrating or rotating the substrate 22, or repositioning the substrate 22 within the apparatus 10. In general, the substrate 22 provides a surface on which the composite material 14 can be formed. For example, the substrate 22 can have an interior surface, wherein the composite material 14 can be formed on at least a portion of the interior surface (as discussed further below). The substrate 22, having an interior surface, can be for example a glass or plastic tubing, container, tank, mold, or cast. Also, the substrate 22 can have an exterior surface, wherein the composite material 14 can be formed on at least a portion of the exterior surface. The substrate 22 having an exterior surface can be for example a glass slide, a silicon or sapphire wafer, or an airplane wing. Further, the substrate 22 can have an interior surface and an exterior surface, wherein the composite material 14 is formed on at least a portion of the interior surface and at least a portion of the exterior surface.

Although the substrate 22 has been described by way of example as being glass, plastic, silicon, sapphire, or metal, it should be understood that the substrate 22 can include any inorganic or organic material, or combination of materials, on which the composite material 14 can be formed. Further, a combination of materials can be used wherein one of the materials of the substrate 22, on which at least a portion of the composite material 14 is to be disposed, is mechanically weak. In such an embodiment, another material of the substrate 14 can give support to the weaker material. For example, if one of the materials of the substrate 14 is a thin layer of cellulose acetate, then the substrate 14 can further include a glass slide or tube adjacently disposed to the thin layer of cellulose acetate to add mechanical strength and/or give shape to the thin layer of cellulose acetate so that at least a portion of the composite material 14 can be more readily disposed on the thin layer of cellulose acetate.

Also, a combination of materials can be used for the substrate 22, wherein one of the materials of the substrate 22 does not have properties conducive to the formation of the composite material 14, and another material of the substrate 22 on which the composite material 14 can be formed, coats or covers, permanently or removably, at least a portion of the non-conducive material of the substrate 22. Alternatively, the substrate 22 may include a material that is conducive to the formation of the composite material 14, wherein a portion of the conducive material is coated or covered, permanently or removably, with a material that is not conducive to the formation of the composite material 14.

In one embodiment, at least a portion of the substrate 22 can be removable so that after the composite material 14 has been formed on at least a portion of the substrate 22, at least a portion of the substrate 22 can be removed from the composite material 14, or at least a portion of the composite material 14 can be removed from the substrate 22. For example, the substrate 22 can give a predetermined shape to the composite material 14 as the composite material 14 is being formed on the substrate 22. Then, after the composite material 14 is formed, the substrate 22 can be removed from the composite material 14, or the composite material 14 can be removed from the substrate 22, so that the composite material 14 is free-standing. For example, if the substrate 22 is a flexible tube made of a material which bonds to the composite material 14 so as to allow the composite material 14 to be formed on the substrate 22 while not preventing the peeling off of the composite material 14, then after the composite material 14 has formed on the substrate 22, for example where the composite material 14 is a film on an interior surface on the tube, then the composite material 14 can be peeled off due to the flexibility of the tube.

In another example, the removable portions of the substrate 14 can confine adjacent portions of the substrate 22 from the composite material 14 such that when the removable portions of the substrate 22 are removed, the adjacent portions of the substrate 22 are free of composite material 14.

The composite material 14 formed on at least a portion of the substrate 22 comprises the plurality of layers 18 of the at least one deposition material 30. Each layer 18 (only four being shown in FIG. 2 for purposes of clarity) of the composite material 14 is formed by exposing at least a portion of the substrate 22 to the at least one deposition material 30 such that a layer of the at least one deposition material is disposed on at least a portion of the substrate 22 or a previously disposed layer 18. Preferably, the plurality of layers 18 are alternating layers of at least two different deposition materials 30, wherein molecules of each deposition material 30 has an affinity for molecules of the other deposition material 30. For example, a first deposition material 30a can be polyethylenenimine, and a second deposition material 30b can be single wall carbon nanotubes. The alternating layers 18 can be formed by alternating exposure of the different deposition materials 30 to at least a portion of the substrate 22 until the desired number of layers 18 have been disposed, or the desired thickness of the composite material 14 has been achieved.

Although the composite material 14 is described by way of example as having layers 18 of polyethylenenimine and single wall carbon nanotubes, other materials can be used to make the plurality of layers 18 of the composite material 14, such as for example, polyelectrolytes, montmorillonite clay, nanotubes, nanoparticles, and/or biological molecules (e.g., growth factor, collagen, etc.). Further, although the composite material 14 is described by way of example as having alternating layers 18 of two different deposition materials, it should be understood that more than two different deposition materials 30 can be utilized to form the layers 18 so long as the deposition materials 30 have an affinity for adjacently disposed deposition materials, and the layers 18 of different deposition materials 30 can be arranged in any pattern accordingly.

In one embodiment of the present invention, each layer 18 of the composite material 14 is formed by exposing at least a portion of the substrate 22 to a solution 36 which includes the at least one deposition material 30 (only two being shown in FIG. 1a for purposes of clarity). Preferably, the solution 36 is fluid or semifluid so that the at least one deposition material 30 therein can be readily traversed to the substrate 22 by the deposition system 34. In one embodiment, the solution is aqueous. Also, the solution 36 is preferably a suspension so as to reduce settling of the at least one deposition material 30 in the solution 36.

The deposition system 34 of the apparatus 10 selectively traverses the solution 36 having the at least one deposition material 30 therein to the substrate 22 such that one of the layers 18 of the at least one deposition material 30 is disposed on at least a portion of the substrate 22 or on a previously disposed layer 18 of the at least one deposition material 30. In one preferred embodiment, the deposition system 34 traverses the solution 36 having the at least one deposition material 30 therein to the deposition cell 26 which includes the substrate 22.

In one embodiment, such as for example shown in FIG. 1b, when the substrate 22 has an interior space 40 (shown in phantom) defined by an interior surface 44 (shown in phantom), a portion of which the composite material 14 is formed on, the deposition system 32 traverses the solution 36 having the at least one deposition material 30 therein to at least a portion of the interior space 40 of the substrate 22 of the deposition cell 26.

In another embodiment, such as shown for example in FIG. 1c, when the substrate 22 (shown in phantom) has an exterior surface 48 (shown in phantom), a portion of which the composite material 14 is disposed on, the deposition cell 26 further includes a container 52 having an interior space 56 (shown in phantom), and at least a portion of the substrate 22 is disposed in the interior space 56 of the container 52. The deposition system 32 traverses the solution 36 having the at least one deposition material 30 therein to at least a portion of the interior space 56 of the container 52 of the deposition cell 26. In such an embodiment, the container 52 can further support at least a portion of the substrate 22.

In one embodiment, to confine at least a portion of the substrate 22 so as to prevent at least a portion of the substrate 22 from being exposed to the solution 36, the container 52 can further include one or more confinement surfaces which partially or totally confine the solution 36 from at least a portion of the substrate 22 when the solution 36 is traversed to at least a portion of the interior space 56 of the container 52. Further, the container 52 can be pressurized to ensure confinement such that only the solution 36, which can be liquid or gas, touches only the portion of the substrate 22 being coated. The objective of this embodiment is to dispose the composite material 14 on at least a portion of the substrate 22 by the inventive process without immersing or exposing the entire substrate 22 to the at least one deposition material 30.

For example, as shown in FIGS. 3a-b, the container 52 can be a flexible bladder 60 having at least one confinement surface 64 which is attachable to at least a portion of the substrate 22. For example, if a portion of an aircraft wing is to be coated, the at least one confinement surface 64 of the bladder 60 can be attached or adhered to the aircraft wing such that an interior space 68 of the bladder 60 is disposed about the portion of the aircraft wing to be coated. The bladder 60 is then filled with one deposition material 30 after another to deposit the layers 18 of the composite material 14 on the portion of the aircraft wing confined in the interior space 68 of the bladder 60. Thus, when the at least one deposition material 30 is traversed to the bladder 60, only the portion of the airplane to which the bladder 60 is attached and which is confined by the interior space 68 of the bladder 60 will be exposed to the solution 36. The remaining portion of the airplane to which the interior space 68 of the bladder 60 does not confine is not exposed to the solution 36. Such an embodiment allows portions of the substrate 22, such as the wings of the airplane, to be coated without moving, disassembling, removing, protecting, immersing, etc., the other portions of the substrate 22 which will not be coated.

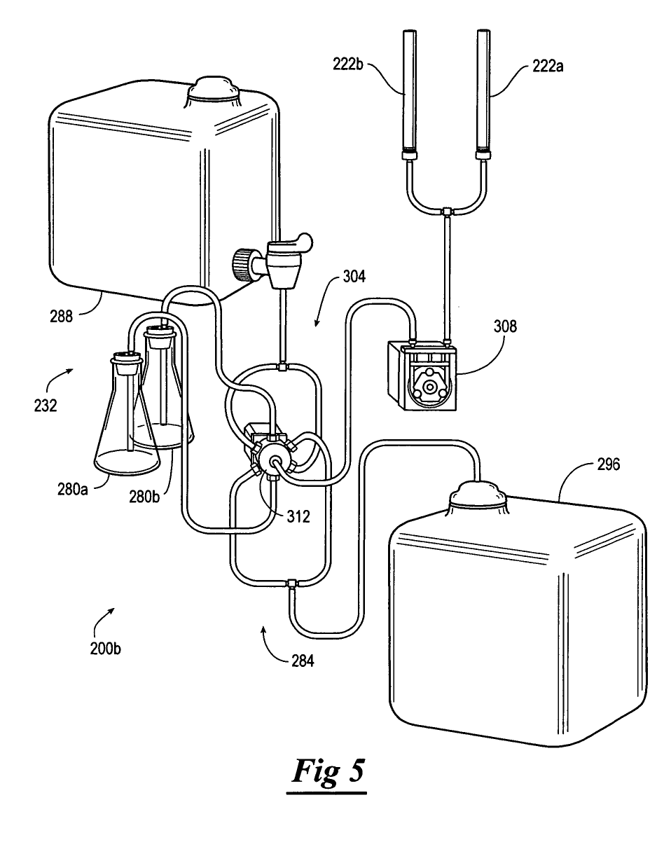

As shown for example in FIG. 1b, the deposition cell 26 of the apparatus 10 can further include a holder assembly 72 for supporting at least a portion of the substrate 22 and/or the container 52. For example, if the substrate 22 is tubing, the holder assembly 74 can be a reel around which the tubing is disposed (see FIG. 5). However, it should be understood that the holder assembly 72 is optional since the substrate 22 and/or container 52 can be self-supporting. Also, the apparatus 10 can further include a cell support 76 for supporting at least a portion of the deposition cell 26, as shown for example in FIG. 1a. For example, when the deposition cell 26 includes the container 52 or the reel, the cell support 76 can be a ring clamp and clamps supporting the container 52 or reel. However, it should be understood that the cell support 76 is optional since the deposition cell 26 can be self-supporting.

The deposition cell 26 can further include an agitator (not shown) for agitating the solution in the deposition cell so as to facilitate the formation of one of the layers 18 of the at least one deposition material 30 on at least a portion of the substrate 22 or a previously disposed layer 18 of the at least one deposition material 30. For example, the agitator can be a mechanical and/or electrical stirrer, such as a motor with an off-axis mass attached to its shaft, or an ultrasonic generator. Further, the apparatus 10 and/or deposition cell 26 can include other deposition promotion devices, such as for example, a heat source, an air source, or an electrophoresis or cataphoresis electrode system.

The deposition system 32 includes at least one material reservoir 80 (only two being shown for purposes of clarity) for storing the at least one deposition material 30, and a transportation system 84 for traversing the at least one deposition material 30 from the at least one material reservoir 80 to the deposition cell 26. The transportation system 84 further traverses the at least one deposition material 30 from the deposition cell 26. When the deposition material 30 is in the solution 36, the material reservoir 80 can further store the solution 36 having the at least one deposition material 30 therein, and the transportation system 84 can further traverse the solution 36 to and from the deposition cell 26.

The deposition system 32 can further include a rinse reservoir 88 for storing a rinse solution 92, wherein the rinse solution 92 is also traversed by the transportation system 84 to and from the deposition cell for rinsing at least one of the transportation system 84, the deposition cell 26, or the substrate 22. In one embodiment, the rinse solution 92 is water. Further, the deposition system 32 can include a waste reservoir 96 for storing waste materials 100, which can include for example the solution 36 or rinse solution 92 traversed from the deposition cell 26 by the transportation system 84.

In one embodiment, the transportation system 84 includes a plurality of channels 104, a pumping device 108, a valve device 112, and a controller 116. The plurality of channels 108 provide passageways to and from at least a portion of the deposition cell 26 so that at least one of the solutions 36, deposition materials 30, rinse solution 92, or waste material 100 can be traversed to and from at least a portion of the deposition cell 26. The pumping device 108 pumps, raises, compresses, propels, projects, draws, or transfers at least one of the deposition materials 30, solutions 36, rinse solution 36, or waste material 50 through at least one of the channels 104. The pumping device 108 can include for example one or more mechanical and/or electrical pumps or pressurized tanks. The valve device 112 selectively allows passage through at least one of the channels 104. The valve device 112 can include for example one or more mechanical and/or electrical valves. The controller 116 controls the valve device 112 via a direct, indirect, or wireless communication link 117. The controller 116 can include for example a computer.

Preferably, the plurality of channels 104 are made of a material, or combination of materials, and constructed so as to eliminate or minimize stagnation, coagulation, and deposition of the deposition material 30, or any other materials passing therethrough. For example, the plurality of channels 104 can include smooth-wall tubes or pipes and connector fittings, which are made of or coated with inert materials, such as plastics, Teflon, poly vinyl chloride, etc. Further, the channels 104, any fittings or other interfaces between the tubes or pipes of the channels, or any fittings or other interfaces between the channels 104 and other components (such as the pumping device 108, valve device 112, at least one material reservoir 34, rinse reservoir 88, waste reservoir 96, or deposition cell 26) can be tapered, chamfered, smoothed, melded, etc., (see exhibits C and D) so as to minimize recesses or other areas likely to promote stagnation, coagulation, and/or undesired deposition.

In one embodiment of the present invention, the apparatus 10 includes a first solution 36a and a second solution 36b, wherein the first solution 36a has a first deposition material 30a having molecules with an affinity for molecules of a second deposition material 30b in the second solution 36b. The first solution 36a having the first deposition material 30a therein is disposed in a first material reservoir 80a, and the second solution 36b having the second deposition material 30b therein is disposed in a second material reservoir 80b. To form the composite material 14 having the plurality of layers 18 on at least a portion of the substrate 22, the controller 116 controls the valve device 112 to allow passage of the first solution 36a through a portion of the channels 104 forming a passageway from the first material reservoir 80a to the deposition cell 26. The pumping device 108 of the transportation system 84 then pumps the first solution 36a to at least a portion of the deposition cell 26 having the substrate 22 so as to fill at least a portion of the deposition cell 26 such that a layer of the first deposition material 30a is disposed on at least a portion of the substrate 22 thereby forming one of the layers 18 of the composite material 14. Preferably, the first solution 36a remains in the deposition cell 26 for a predetermined time so as to allow deposition of the layer 18 of the first deposition material 30a by the controller 116 controlling the valve device 112 to close one of the valves of the valve device 112 so as to prevent passage through the portion of the channels 104 allowing passageway from the deposition cell 26.

The controller 116 of the transportation system 84 then controls the valve device 112 so as to open valves of the valve device 112 so as to allow a passageway from the deposition cell 26 to the waste reservoir 96. The pumping device 108 pumps the first solution 36a having the undisposed first deposition material 30a therein from the deposition cell 26 to the waste reservoir 96 so as to purge the deposition cell 26. The deposition system 32 then rinses at least a portion of the deposition cell 26 by traversing the rinse solution 92 from the rinse reservoir 88 to the deposition cell 26, and from the deposition cell 26 to the waste reservoir 96 in a similar manner as the first solution 36a. In a similar manner as the first solution 36a, the deposition system 32 then traverses the second solution 36b having the second deposition material 30b therein to at least a portion of the deposition cell 26 having the substrate 22 such that a layer of the second deposition material 30b is disposed on at least a portion of the previously disposed layer 18 of the first deposition material 30a so as to form another layer 18 of the composite material 14. The deposition system 32 then traverses the second solution 36b having the undisposed second deposition material 30b from at least a portion of the deposition cell 26 to the waste reservoir 96, in a similar manner as the first solution 36a. Then the deposition system 32 again rinses at least a portion of the deposition cell 26 by traversing the rinsing solution 92 from the rinse reservoir 88 to the deposition cell 26 and from the deposition cell 26 to the waste reservoir 96.

The steps of traversing the first solution 36a to and from the deposition cell 26, rinsing with the rinse solution 88, traversing the second solution 36b to and from the deposition cell 26, and rinsing with the rinse solution 88 can be repeated until the desired number of layers 18 of the composite material 14 are disposed. Although the above method has been described with two solutions 36a and 36b, it should be apparent to one of ordinary skill in the art that any number of solutions 36 may be used so long as the deposition material 30 in each solution 36 has an affinity for the deposition material 30 to which it will be adjacently disposed. Further, one of ordinary skill in the art would also understand that while the steps of traversing the first and second solutions 36a and 36b to and from the deposition cell 26 are discussed as being arranged such that the layers 18 of the composite material 14 would have alternating layers 18 of the deposition materials 30a and 30b, the steps of traversing the solutions 36 to and from the deposition cell 26 can be arranged in any manner so as to form any desired arrangement or pattern of adjacently disposed layers 18.

In one embodiment, when the substrate 22 of the deposition cell 26 has the interior space 40 defined by the interior surface 44, the step of traversing the first solution 36a to at least a portion of a deposition cell 26 comprises the deposition system 32 traversing the first solution 36a to at least a portion of the interior space 40 of the substrate 22, and the step of traversing the second solution 36b to at least a portion of a deposition cell 26 comprises traversing the second solution 36b to at least a portion of the interior space 40 of the substrate. Likewise, the step of traversing the first solution 36a from at least a portion of the deposition cell 26 comprises traversing the first solution 36a from at least a portion of the interior space 40 of the substrate 22, and the step of traversing the second solution 36b from at least a portion of the deposition cell 26 comprises traversing the second solution 36b from at least a portion of the interior space 40 of the substrate 22. Also the steps of rinsing at least a portion of the deposition cell 26 comprises rinsing at least a portion of the interior space 40 of the substrate 22.

In another embodiment, when the deposition cell 26 of the apparatus 10 comprises the substrate 22 having an exterior surface 48 and the container 52 having an interior space 56, wherein at least a portion of the substrate 22 is disposed in the interior space 56 of the container 52, the step of traversing the first solution 36a to at least a portion of a deposition cell 26 comprises the deposition system 32 traversing the first solution 36a to at least a portion of the interior space 56 of the container 52, and the step of traversing the second solution 36b to at least a portion of a deposition cell 26 comprises traversing the second solution 36b to at least a portion of the interior space 56 of the container 52. Likewise, the step of traversing the first solution 36a from at least a portion of the deposition cell 26 comprises traversing the first solution 36a from at least a portion of the interior space 56 of the container 52, and the step of traversing the second solution 36b from at least a portion of the deposition cell 26 comprises traversing the second solution 36b from at least a portion of the interior space 56 of the container 52. Also the steps of rinsing at least a portion of the deposition cell 26 comprises rinsing at least a portion of the interior space 56 of the container 52.

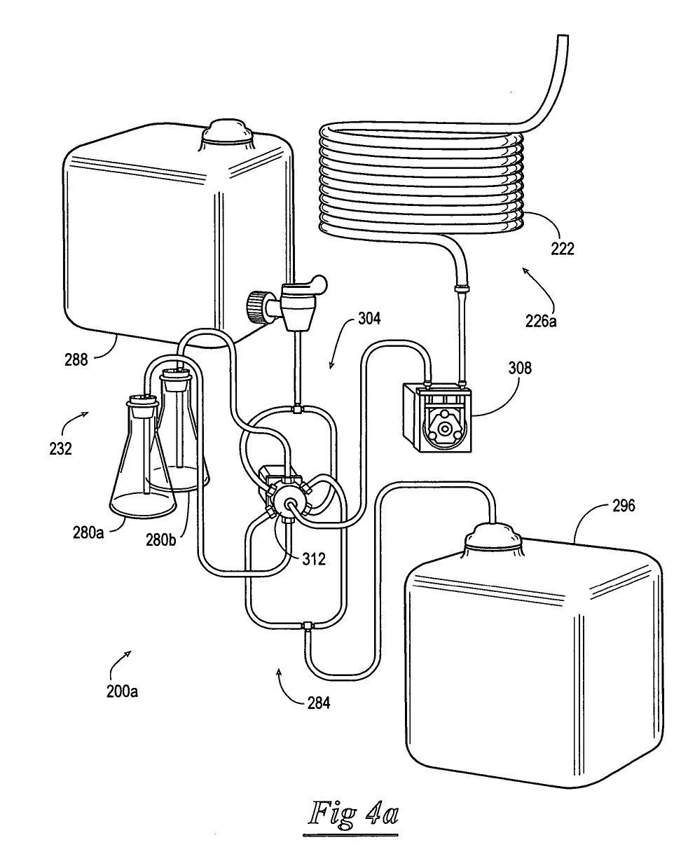

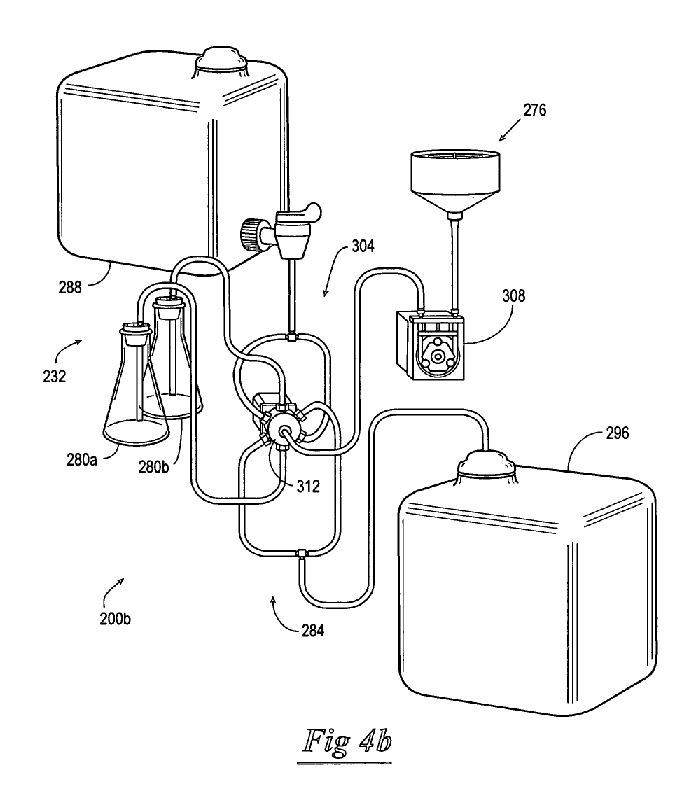

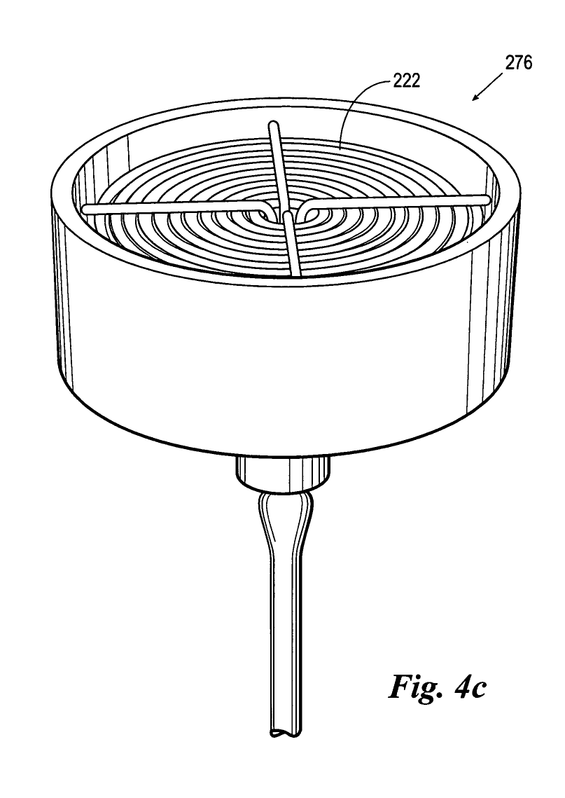

Referring now to FIG. 4a, shown therein is one embodiment of an apparatus 200a, constructed in accordance with the present invention. The apparatus 200a includes a deposition cell 226a and a deposition system 232 having a first material reservoir 280a, a second material reservoir 280b, a rinse reservoir 288, a waste reservoir 296, and a transportation system 284 having a plurality of channels 304, a pumping device 308, a valve device 312, and a controller (not shown). The deposition system 232 includes a substrate 222 (which can include for example tubing). The deposition cell 226a of apparatus 200a can further include a holder assembly 274 for supporting at least a portion of the substrate 222, such as shown for example in FIG. 4b-c, wherein the holder assembly 274 includes a reel 276 for supporting the substrate 222.

As discussed above, the present invention contemplates the deposition cell 26 having more than one substrate 22. For example, referring to FIG. 5, shown therein is one embodiment of an apparatus 200b, constructed in accordance with the present invention. The apparatus 200b is similar to apparatus 200a shown in FIG. 4a, in that apparatus 200b includes the deposition system 232 having the first material reservoir 280a, the second material reservoir 280b, the rinse reservoir 288, the waste reservoir 296, and the transportation system 284 having the plurality of channels 304, the pumping device 308, the valve device 312, and the controller (not shown). However, the apparatus 200b has a deposition cell 226b which includes two substrates 222a and 222b (which can include for example tubing).

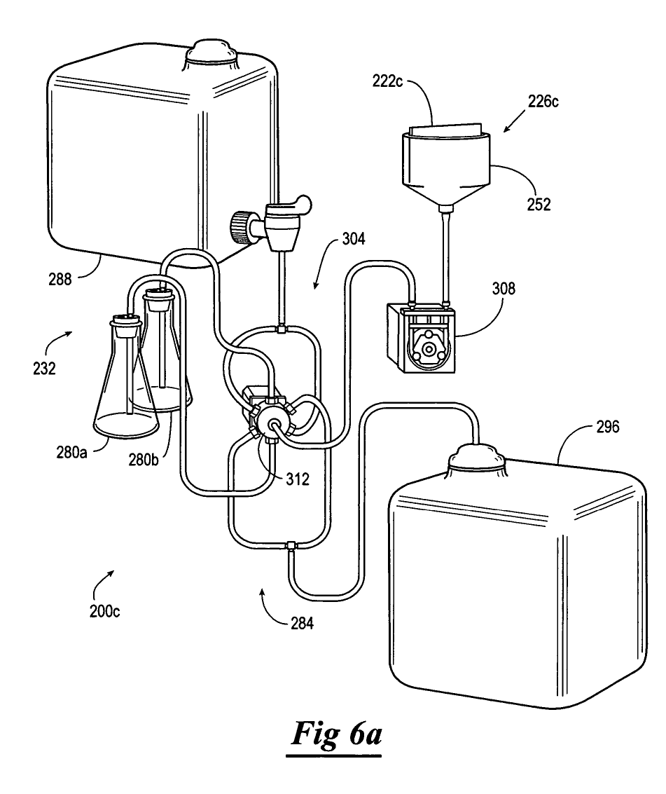

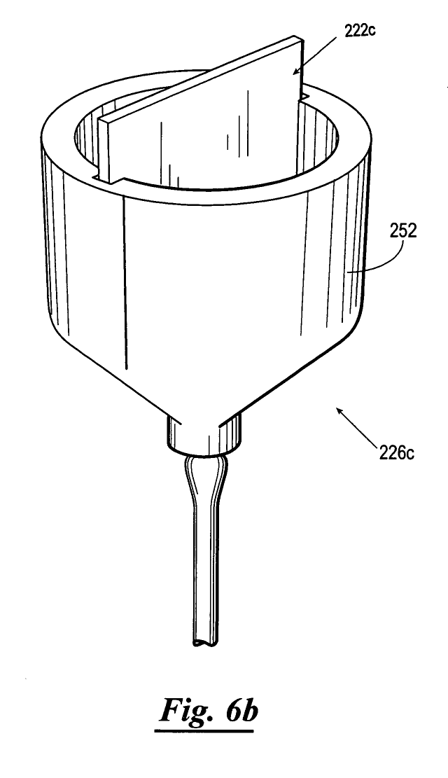

Referring now to FIGS. 6a-b, shown therein is one embodiment of an apparatus 200c, constructed in accordance with the present invention. The apparatus 200c is similar to apparatus 200a shown in FIG. 4a, in that apparatus 200b includes the deposition system 232 having the first material reservoir 280a, the second material reservoir 280b, the rinse reservoir 288, the waste reservoir 296, and the transportation system 284 having the plurality of channels 304, the pumping device 308, the valve device 312, and the controller (not shown). However, the apparatus 200c has a deposition cell 226c which includes a substrate 222c (which can include for example a film and/or slide) and a container 252, wherein at least a portion of the substrate 222c is disposed in and supported by the container 252 (as best illustrated in FIG. 6b).

Attached is Exhibit A, Exhibit B, Exhibit C, Exhibit D, Exhibit E, and Exhibit F, the contents of which are hereby expressly incorporated herein by reference, that more specifically describe the invention, the production thereof, and uses thereof in greater detail. However, although the foregoing invention has been described in some detail by way of illustration and example for purposes of clarity of understanding, it will be apparent to those skilled in the art that certain changes and modifications may be practiced without departing from the spirit and scope thereof, as described herein and in the above-referenced attachments.

1. An apparatus for forming a composite material having a plurality of layers disposed on at least a portion of at least one substrate, the apparatus comprising:
at least one deposition cell having at least one substrate;
at least two reservoirs with each reservoir adapted to contain a deposition material for forming the plurality of layers of the composite material; and
a deposition system in fluid communication with the reservoirs for selectively removing the deposition materials from the reservoirs and traversing the deposition materials near the at least one substrate such that separate layers of the deposition materials are disposed on at least a portion of the at least one substrate to form the composite material.

2. The apparatus of claim 1 wherein the at least one substrate has an interior surface and wherein at least a portion of the composite material is formed on the interior surface.

3. The apparatus of claim 1 wherein the at least one substrate has an exterior surface wherein the composite material is formed on at least a portion of the exterior surface.

4. The apparatus of claim 1 wherein the at least one substrate has an interior surface and an exterior surface wherein the composite material is formed on at least a portion of the interior surface and at least a portion of the exterior surface of the at least one substrate.

5. The apparatus of claim 1 wherein the at least one substrate is used to give a predetermined shape to the composite material.

6. The apparatus of claim 1 wherein the at least one substrate has an exterior surface and the deposition cell includes a container having an interior space wherein at least a portion of the exterior surface of the substrate is disposed in the interior space of the container.

7. The apparatus of claim 1 wherein the at least one deposition cell includes a container wherein the container has at least one confinement surface which partially confines at least one of the deposition materials from at least a portion of the at least one substrate so that at least a portion of the at least one substrate is not exposed to at least one of the deposition materials.

8. The apparatus of claim 1 wherein the deposition cell comprises a holder assembly for supporting at least a portion of the substrate.

9. The apparatus of claim 1 wherein the deposition system selectively traverses a rinse near the at least one substrate in the at least one deposition cell.

10. The apparatus of claim 9 wherein the deposition system cycles between selectively traversing at least one of the deposition materials and selectively traversing the rinse near the at least one substrate.

11. The apparatus of claim 10 wherein the deposition system is provided with a programmed controller for controlling the cycling between selectively traversing at least one of the deposition materials and selectively traversing the rinse near the at least one substrate.

12. The apparatus of claim 11 further comprising an electrophoresis system for enhancing and accelerating the deposition of at least one of the deposition materials on at least a portion of the at least one substrate.

13. The apparatus of claim 11 further comprising an electrophoresis system for precluding the deposition of at least one of the deposition materials on at least a portion of the at least one substrate.

14. The apparatus of claim 1 further comprising a temperature control source for enhancing and accelerating the deposition of at least one of the deposition materials on at least a portion of the at least one substrate.

15. A process for forming a composite material having a plurality of layers disposed on at least a portion of at least one substrate, the steps of the process, comprising:
a. positioning at least one substrate in a cavity of at least one deposition cell;
b. selectively traversing at least two deposition materials to the cavity of the at least one deposition cell such that a layer of the deposition materials is disposed on at least a portion of the at least one substrate thereby forming at least one of the layers of the composite material;
c. removing the at least one deposition material from the cavity of the deposition cell;
d. selectively traversing a rinse to the cavity of the deposition cell;
e. removing the rinse from the cavity of the deposition cell; and
f. repeating steps b-e to form the layers of the composite material.

16. The process of claim 15 wherein the at least one substrate is stationary.

17. The process of claim 15 wherein the at least one substrate has an interior surface and wherein at least a portion of the composite material is formed on the interior surface.

18. The process of claim 15 wherein the at least one substrate has an exterior surface wherein the composite material is formed on at least a portion of the exterior surface.

19. The process of claim 15 wherein the at least one substrate has an interior surface and an exterior surface wherein the composite material is formed on at least a portion of the interior surface and at least a portion of the exterior surface of the at least one substrate.

20. The process of claim 15 wherein the at least one substrate is used to give a predetermined shape to the composite material.

21. The process of claim 15 wherein the at least one substrate has an exterior surface and the deposition cell includes a container having an interior space wherein at least a portion of the exterior surface of the substrate is disposed in the interior space of the container.

22. The process of claim 15 wherein the at least one deposition cell includes a container wherein the container has at least one confinement surface which partially confines the at least one deposition material from at least a portion of the at least one substrate so that at least a portion of the at least one substrate is not exposed to the at least one deposition material.

23. The process of claim 15 wherein the deposition cell comprises a holder assembly for supporting at least a portion of the at least one substrate.

24. The process of claim 15 wherein a continuous or intermittent flow is utilized through at least one deposition cell.
